(19) United States
(12) Patent Application Publication
(10) Pub. No.: US 2018/0290637 A1
(43) Pub. Date: Oct. 11, 2018

(54) TONE RING WITH PROTECTIVE FILLER

(71) Applicant: Hendrickson USA, L.L.C., Itasca, IL (US)

(72) Inventors: Jay D. White, Massillon, OH (US); Dhawal P. Dharaiya, Twinsburg, OH (US)

(21) Appl. No.: 15/927,147

(22) Filed: Mar. 21, 2018

Related U.S. Application Data
(60) Provisional application No. 62/482,257, filed on Apr. 6, 2017.

(51) Int. Cl. B60T 8/32; G01P 1/02; B60T 8/54

(52) U.S. Cl. CPC B60T 8/329; G01P 3/443; B60T 8/54; G01P 1/02

(57) ABSTRACT

A tone ring for a heavy-duty vehicle anti-lock braking system (ABS) that includes a filler disposed within spaces or notches between teeth formed in the tone ring. The filler is formed of a material that does not interfere with the ability of an ABS sensor to sense the teeth. In one embodiment, the filler includes a plurality of protrusions disposed within the spaces formed between the teeth. The plurality of protrusions are integrally formed with a base that extends circumferentially around the side of the tone ring opposite the ABS sensor. In another embodiment, the filler includes a plurality of fillings disposed within notches formed between the teeth. The filler prevents road debris and/or contaminants from damaging the tone ring teeth and damaging and/or misaligning the ABS sensor. A thin coating can extend over the tone ring teeth and the plurality of protrusions or fillings to encapsulate the teeth.

### CROSS-REFERENCE TO RELATED APPLICATION

This application claims the benefit of U.S. Provisional Patent Application Ser. No. 62/482,257, filed Apr. 6, 2017.

### BACKGROUND OF THE INVENTION

### Technical Field

The invention relates to heavy-duty vehicle anti-lock braking systems (“ABS”), and in particular, to the tone ring component of such systems. More particularly, the invention is directed to an ABS tone ring for a heavy-duty vehicle ABS of the type attached to a disc brake rotor or integrated into the vehicle disc brake rotor or wheel hub. Even more particularly, the invention relates to a tone ring for a heavy-duty vehicle ABS that includes a filler disposed between the tone ring teeth. The filler minimizes the potential for road debris to strike and bend or otherwise damage the tone ring teeth, prevents road debris from becoming lodged between the teeth and subsequently damaging or misaligning the ABS sensor, and provides corrosion protection to the tone ring teeth during operation of the heavy-duty vehicle, thereby increasing the tone ring life, minimizing vehicle maintenance and repair costs, and enhancing ABS safety.

### Background Art

Anti-lock braking systems, more commonly referred to as ABS, have become common safety equipment on virtually every type of vehicle ranging from cars to semi-trailers. In heavy-duty vehicles such as straight trucks and semi-trailers, U.S. government regulations require at least one axle of a tandem axle configuration, commonly found on such vehicles, to include an ABS sensor on each end of that axle. Some manufacturers of such heavy-duty vehicles go beyond government regulations and include ABS sensors on every axle to improve ABS performance.

Each ABS sensor is generally located adjacent to the inboard facing end of the vehicle wheel end assembly rotatably mounted on the vehicle axle. The ABS also includes a tone ring mounted or formed on a component of the vehicle wheel end assembly associated with each ABS sensor. The tone ring is typically attached directly to the inboard end of a wheel hub of the wheel end assembly, or alternatively, incorporated into a disc brake rotor, which in turn is attached to the inboard end of the wheel hub. The tone ring is generally circular and includes a plurality of notches, protrusions, teeth, or similar divisions, hereinafter generally referred to as teeth, formed of a magnetic material capable of altering magnetic fields which are produced and detected by the associated ABS sensor. As the vehicle is operated, because the tone ring is attached to, or integrated with, a respective vehicle wheel hub or disc brake rotor, the tone ring rotates with the wheel hub or disc brake rotor. As is well-known to those skilled in the art, the ABS sensor is attached to the vehicle axle, or other stationary vehicle component, in close proximity to the associated tone ring so that it is capable of detecting the magnetic field disruption produced by each tone ring tooth. More specifically, the ABS sensor detects certain movements, such as distance and rotational velocity and change in velocity of the tone ring teeth, which in turn causes an electrical signal to be sent to the ABS electronic control unit enabling control of brake engagement. Thus, it is important that the ABS sensor be precisely positioned on the vehicle axle inboardly adjacent to and aligned with the tone ring teeth so that it can properly perform its sensing function.

All tone rings, whether attached to or integrated with a vehicle wheel hub or disc brake rotor, are exposed to the environment under the vehicle, which can negatively affect the vehicle ABS. More specifically, as a vehicle is traveling on a roadway, flying road debris can strike and bend or otherwise damage the tone ring teeth, or become lodged between the teeth, which can undesirably alter the magnetic field disruption repeatability produced by the teeth, and/or contact and damage or misalign the ABS sensor. In heavy-duty vehicle off-road applications, the potential for damage of the tone ring teeth and/or damage or misalignment of the ABS sensor from debris is substantially increased due to the vehicle being exposed to greater concentrations of debris. In addition, contaminants, such as water, brine, or road salts, can splash on the tone ring during operation of the vehicle, and in turn potentially corrode the tone ring teeth. Damage to the tone ring teeth and/or damage or misalignment of the ABS sensor can in turn lead to an ABS fault, requiring the vehicle to be serviced to replace the damaged ABS components or realign the sensor, resulting in vehicle down time. In addition, most heavy-duty vehicles are required to be equipped with a visual indicator on the exterior of the heavy-duty vehicle, such as a heavy-duty vehicle trailer, and on the heavy-duty vehicle truck or tractor interior dash, to alert the driver or a transportation inspection authority of a potentially improperly functioning ABS, which could result in the issuance of a citation by such authorities if the vehicle is operated under such circumstances.

Thus, there is a need in the art for a tone ring which minimizes the potential for damage to the tone ring and/or damage or misalignment of the ABS sensor due to debris encountered during operation of a heavy-duty vehicle, and which minimizes potential damage to the tone ring from corrosion caused by contaminants encountered during operation of the vehicle. The tone ring with protective filler of the present invention satisfies these needs, as will be described below.

### BRIEF SUMMARY OF THE INVENTION

An objective of the present invention is to provide a tone ring for heavy-duty vehicles that minimizes the potential for road debris to strike and bend or otherwise damage the tone ring teeth during vehicle operation.

Another objective of the present invention is to provide a tone ring for heavy-duty vehicles that prevents road debris from becoming lodged between the tone ring teeth and potentially damaging or misaligning the ABS sensor during vehicle operation.

Yet another objective of the present invention is to provide a tone ring with improved corrosion protection to the tone ring teeth during vehicle operation.

Still another objective of the present invention is to provide a tone ring with increased life.

Yet another objective of the present invention is to provide a tone ring that minimizes vehicle maintenance costs.

Still another objective of the present invention is to provide a tone ring that enhances ABS safety.

These objectives and others are achieved by the tone ring with protective filler of the present invention, which includes a body, the body including a plurality of divisions formed of a material capable of being sensed by a sensor of said anti-lock braking system; and a filler, the filler being disposed at least between adjacent ones of the divisions and being formed of material that does not interfere with the ability of the sensor to sense the divisions, whereby the filler provides protection to the divisions and the sensor.

### BRIEF DESCRIPTION OF THE SEVERAL VIEWS OF THE DRAWINGS

The exemplary embodiments of the present invention, illustrative of the best modes in which Applicant has contemplated applying the principles of the present invention, are set forth in the following description and are shown in the drawings.

FIG. 1 is a fragmentary side elevational view, shown partially in cross section, of a disc brake rotor for heavy-duty vehicles incorporated into a wheel end assembly mounted on an axle spindle;

FIG. 2 is a fragmentary top perspective view, looking in an outboard direction, of a heavy-duty vehicle wheel end assembly mounted on a vehicle axle and including a disc brake rotor with a prior art tone ring attached to the rotor and an ABS sensor mounted on the axle;

FIG. 3 is an enlarged top perspective view, looking in an outboard direction, of a portion of the axle and disc brake rotor with attached prior art tone ring of FIG. 2;

FIG. 4 is perspective view, looking in an outboard direction, of a first exemplary embodiment tone ring with protective filler of the present invention;

FIG. 5 is a fragmentary cross-sectional view, looking in a radially outward direction, of a portion of the first exemplary embodiment tone ring with protective filler of FIG. 4, taken along line 5-5, showing the protective filler structure and orientation relative to the tone ring teeth;

FIG. 6 is perspective view, looking in an outboard direction, of a second exemplary embodiment tone ring with protective filler of the present invention;

FIG. 7 is a fragmentary view, looking in a radially outward direction, of a portion of the second exemplary embodiment tone ring with protective filler of FIG. 6, taken along line 7-7, showing the protective filler structure and orientation relative to the tone ring teeth.

Similar numerals refer to similar parts throughout the drawings.

### DETAILED DESCRIPTION OF THE INVENTION

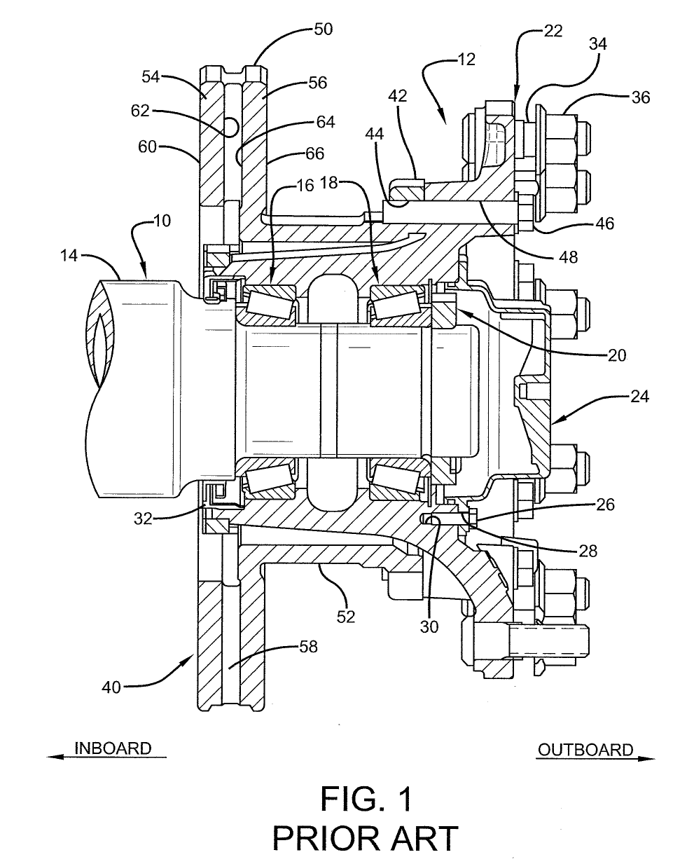

In order to better understand the tone ring with protective filler for a heavy-duty vehicle of the present invention and the environment in which it operates, a prior art heavy-duty vehicle wheel end assembly is shown in FIG. 1, and is indicated generally at 12. Heavy-duty vehicles (not shown) generally include one or more axles 10, which typically depend from and extend transversely under the vehicles. Heavy-duty vehicles include trucks and tractor-trailers or semi-trailers, and trailers thereof. Reference herein shall be made generally to a heavy-duty vehicle for the purpose of convenience, with the understanding that such reference includes trucks, tractor-trailers and semi-trailers, and trailers thereof. Each axle 10 has two ends, with a separate wheel end assembly 12 mounted on each one of the ends. For the purposes of conciseness and clarity, only one end of axle 10 and its respective wheel end assembly 12 will be described herein.

Axle 10 includes a central tube (not shown), and an axle spindle 14 integrally connected to each end of the central tube by any suitable means, such as welding. Wheel end assembly 12 includes a bearing assembly having an inboard bearing 16 and an outboard bearing 18 immovably mounted on the outboard end of axle spindle 14. A spindle nut assembly 20 threadably engages the outboard end of axle spindle 14 and secures inboard and outboard bearings 16, 18 in place. Wheel end assembly 12 includes a wheel hub 22 rotatably mounted on inboard and outboard bearings 16, 18 in a manner well known to those skilled in the art.

Wheel end assembly 12 includes a hubcap 24 mounted on the outboard end of wheel hub 22 by a plurality of bolts 26, each one of which passes through a respective one of a plurality of openings 28 formed in the hubcap, and threadably engages a respective one of a plurality of aligned threaded openings 30 formed in the wheel hub. In this manner, hubcap 24 closes the outboard end of wheel end assembly 12. A main continuous seal 32 is rotatably mounted on the inboard end of wheel end assembly 12 and closes the inboard end of the assembly. In a typical heavy-duty vehicle dual-wheel configuration, a plurality of threaded bolts 34 and mating nuts 36 are used to mount one tire rim or a pair of tire rims (not shown), depending on specific design considerations, on wheel end assembly 12. Each one of a pair of tires (not shown) is mounted on a respective one of the tire rims, as known in the art.

Heavy-duty vehicles often utilize air brake systems that include either disc brakes or drum brakes incorporated into the vehicle wheel end to provide vehicle braking. In heavy-duty vehicles which utilize disc brakes to provide vehicle braking, wheel end assembly 12 generally includes a rotor 40 attached to the wheel hub. More specifically, rotor 40 includes a radially-extending mounting portion or flange 42, which is formed with openings 44 to receive mechanical fasteners 46, such as bolts. Wheel hub 22 is formed with corresponding openings 48, thereby enabling bolts 46 to pass through aligned ones of the wheel hub openings and rotor flange openings 44 to removably secure rotor 40 to the wheel hub. This construction enables rotor 40 to rotate with wheel hub 22, while being removable from the wheel hub for servicing.

Rotor 40 also includes a radially-extending disc portion 50. Disc portion 50 is disposed between a pair of opposing brake pads (not shown) in a manner known in the art. An axially-extending rotor sleeve 52 is integrally formed with and extends between disc portion 50 and flange 42. Sleeve 52 enables rotor disc portion 50 to be rigidly connected to flange 42 and thus wheel end assembly 12.

Disc portion 50 of rotor 40 includes an inboard disc 54 and an outboard disc 56, which are spaced apart from one another and are interconnected by a plurality of vanes 58. More particularly, inboard disc 54 includes an inboard surface 60 and an outboard surface 62, and outboard disc 56 includes an inboard surface 64 and an outboard surface 66. Inboard surface 60 of inboard disc 54 is adjacent the friction material of a respective one of a pair of brake pads (not shown), and outboard surface 66 of outboard disc 56 is adjacent to the friction material of the other one of the pair of brake pads.

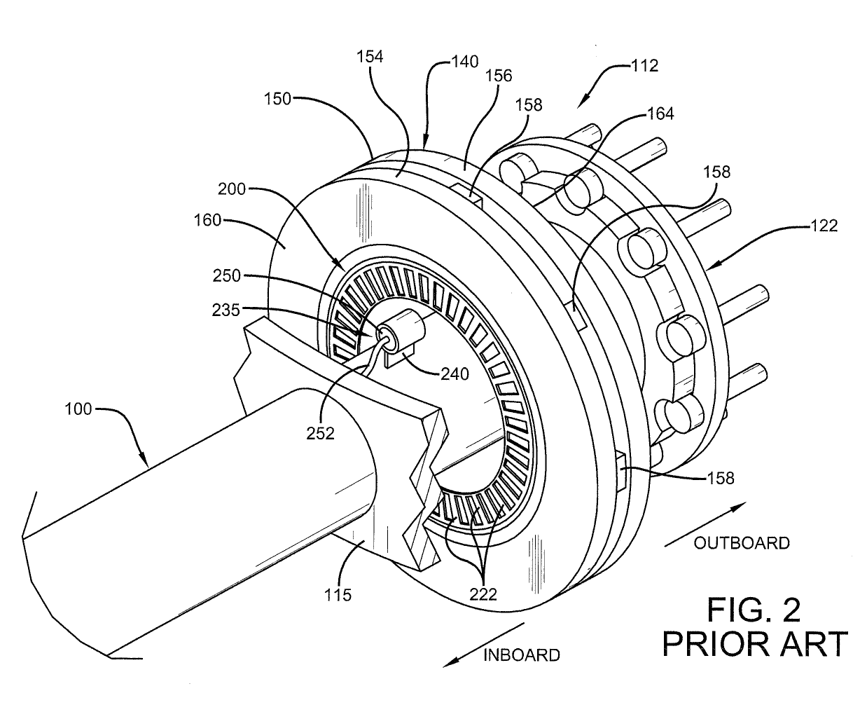

With reference to FIG. 2, a heavy-duty vehicle wheel end assembly rotatably mounted to an axle spindle (not shown) of an axle 100 is shown generally at 112. Wheel end assembly 112 is similar in structure and function to wheel end assembly 12 (FIG. 1), with the exception that the wheel end assembly includes a disc brake rotor 140 incorporating components of an ABS, including a prior art tone ring 200. As a result, only rotor 140 and tone ring 200 will be described in detail.

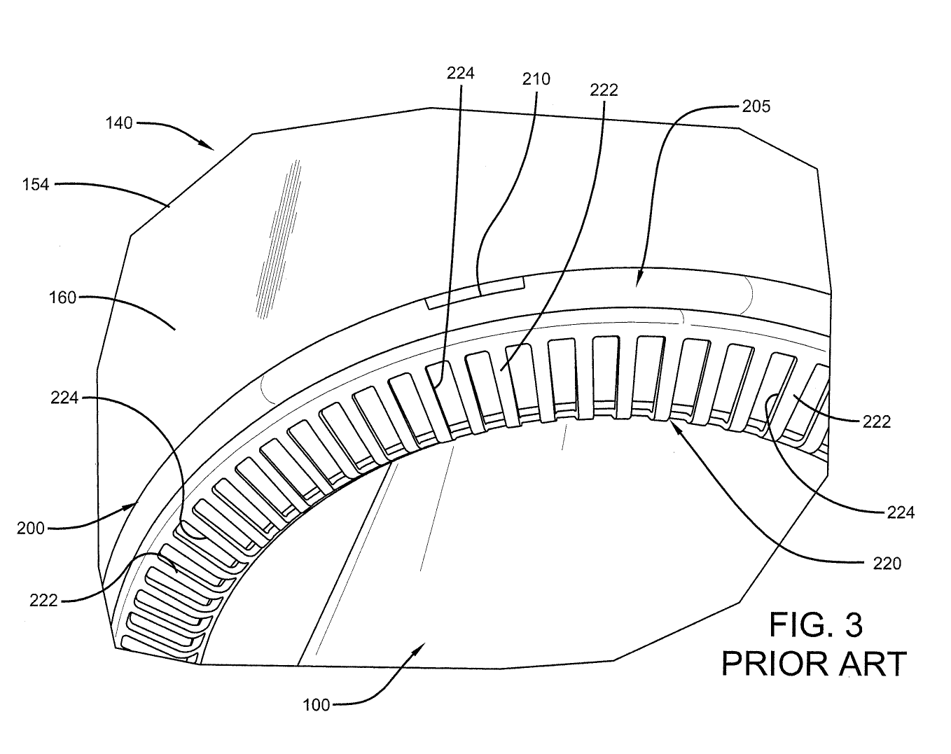

With reference to FIGS. 2 and 3, rotor 140 is generally similar in structure and function to rotor 40 (FIG. 1), with the exception that the rotor enables tone ring 200, a discrete component, to be mounted on the rotor for use with the vehicle ABS. Rotor 140 includes a radially-extending mounting portion or flange (not shown) formed with openings (not shown) to receive mechanical fasteners (not shown), such as bolts, to attach rotor 140 to a wheel hub 122 of wheel end assembly 112, which enables rotor 140 to rotate with the wheel hub, while being removable from the wheel hub for servicing.

With particular reference to FIG. 2, rotor 140 includes a radially-extending disc portion 150 disposed between a pair of opposing brake pads (not shown) in a manner known in the art. An axially-extending rotor sleeve (not shown) is integrally formed with and extends between disc portion 150 and the flange to enable disc portion 150 to be rigidly connected to the flange and thus wheel end assembly 112.

Disc portion 150 of rotor 140 includes an inboard disc 154 and an outboard disc 156, which are spaced apart from one another and are interconnected by a plurality of vanes 158. Inboard disc 154 includes an inboard surface 160, and outboard disc 156 includes an outboard surface 164. Inboard surface 160 of inboard disc 154 is adjacent to the friction material of a respective one of a pair of brake pads (not shown), and outboard surface 164 of outboard disc 156 is adjacent to the friction material of the other one of the pair of brake pads, which provide braking during operation of the vehicle in a known manner. Rotor 140 includes a means for receiving and mounting tone ring 200 in a manner known in the art.

With reference to FIG. 3, tone ring 200 includes a radially extending inner portion 220 and a radially extending outer portion 205. A plurality of notches 210 are formed on outer portion 205 of tone ring 200 and enable the tone ring 200 to be mounted on rotor 140 in a known manner. A plurality of teeth 222 are formed in, and are circumferentially spaced around inner portion 220, the function of which will be described below. A plurality of spaces 224 are disposed between each pair of formed teeth 222 and are circumferentially spaced around inner portion 220.

With reference to FIG. 2, tone ring 200 is utilized in a heavy-duty vehicle ABS 235. ABS 235 generally also includes an ABS sensor 250 of a type which is well-known in the art. ABS sensor 250 is disposed within a bracket 240, which in turn is rigidly attached to axle 100 adjacent to, and slightly inboard of, tone ring 200 by any suitable means, such as welding. ABS sensor 250 is aligned with teeth 222 at an appropriate distance known in the art depending on the sensor utilized. For the sake of relative completeness, a torque plate 115, which mounts other brake components such as a disc brake caliper, is shown mounted on axle 100 inboard of rotor 140 and ABS sensor 250.

Tone ring 200 conventionally is formed of a ferrous material, such as steel, cast iron, magnetic stainless steel, ferrous powder metal, or other suitable magnetic materials. Ferrous materials are utilized because they are magnetic and disrupt magnetic fields produced by ABS sensor 250, enabling the ABS sensor to identify when teeth 222 pass. More specifically, teeth 222 disrupt magnetic fields produced by ABS sensor 250 as tone ring 200 rotates past the sensor during vehicle operation. ABS sensor 250 in turn detects the disruptions and sends signals based on the detected disruption of magnetic fields, such as distance information based on sensed rotational velocity and change of velocity of teeth 222, to an ABS electronic control unit (not shown) via an electrical cable 252. Based on the information received, the electronic control unit is capable of controlling the brake engagement under predefined circumstances as programmed into the unit.

Because tone ring 200 is positioned near the outboard end of axle 100, and in close proximity to the road surface or ground, teeth 222 can potentially become bent or damaged by flying road debris, such as stones, and/or the debris may become lodged within spaces 224 disposed between teeth 222 and potentially damage or misalign ABS sensor 250. Teeth 222 also can be potentially damaged by corrosion caused by contaminants, such as road salt, which splash on the teeth during operation of the vehicle, all of which in turn could lead to a fault of ABS 235, requiring the vehicle to be serviced and resulting in vehicle down time. In addition, if the heavy-duty vehicle is equipped with a visual indicator on the exterior of the vehicle to alert transportation inspection authorities of a potentially improperly functioning ABS 235, and the vehicle is operating under such circumstances, a citation could be issued by such authorities. The tone ring with protective filler of the present invention minimizes potential bending or other damage to the tone ring, and/or potential damage or misalignment of the ABS sensor by road debris, and minimizes corrosion of the tone ring from exposure to road contaminants, and will now be described.

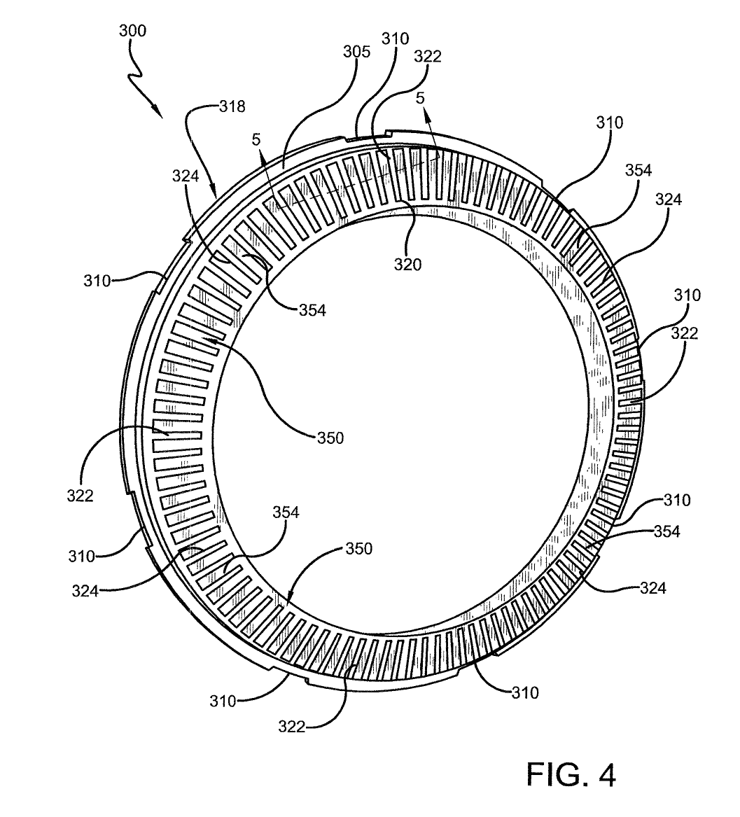

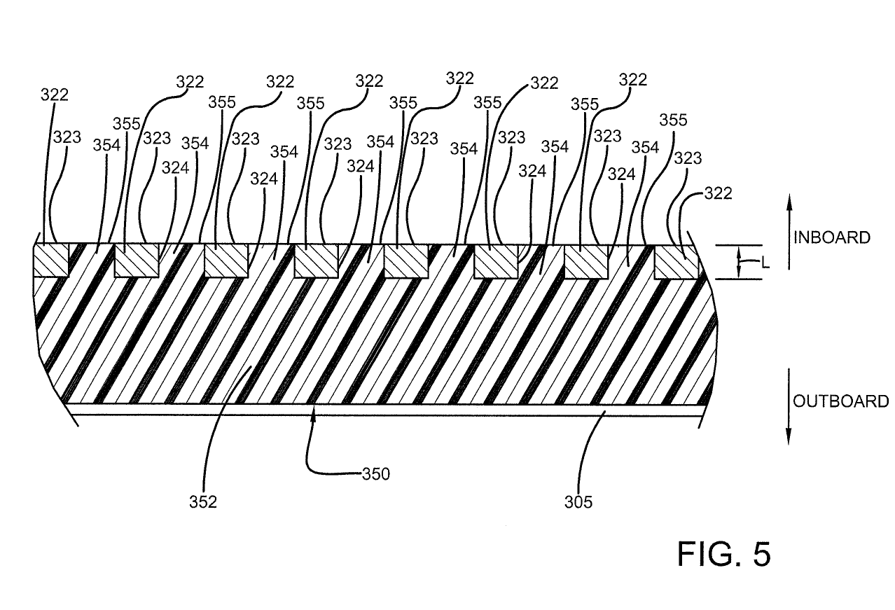

Turning now to the present invention, a first exemplary embodiment tone ring with protective filler for heavy-duty vehicles of the present invention is shown in FIGS. 4-5, and is indicated generally at 300. First exemplary embodiment tone ring with protective filler 300 is a discrete component of the type which is mounted to a rotor, such as rotor 140 described above.

First exemplary embodiment tone ring with protective filler 300 is utilized in a heavy-duty vehicle ABS (not shown), such as ABS 235 (FIG. 2), and functions similarly to tone ring 200 (FIGS. 2-3). First exemplary embodiment tone ring with protective filler 300 includes a body 318 with a radially extending inner portion 320 and a radially extending outer portion 305. A plurality of notches 310 are formed in outer portion 305, and enable first exemplary embodiment tone ring with protective filler 300 to be mounted on the disc brake rotor in a known manner. A plurality of spaces 324 are formed in or blown through inner portion 320, such as by stamping, and are circumferentially spaced around the inner portion 320. A plurality of teeth 322 are formed in inner portion 320 between each pair of spaces 324, and are circumferentially spaced around the inner portion, the function of which will be described below.

Body 318 of first exemplary embodiment tone ring with protective filler 300 is formed of a magnetic material capable of disrupting the magnetic fields produced by an ABS sensor (not shown) of the vehicle ABS, such as ABS sensor 250 described above. Body 318 preferably is formed of a ferrous material, such as steel, cast iron, magnetic stainless steel, or ferrous powder metal, and because of the ferrous material's magnetic properties, can usually be sensed most effectively by the ABS sensor. Because of the magnetic properties of the material used to form body 318, teeth 322 disrupt magnetic fields produced by the ABS sensor as first exemplary embodiment tone ring with protective filler 300 rotates past the ABS sensor during vehicle operation. The ABS sensor in turn detects the disruptions and sends signals based on the detected disruption of magnetic fields, such as distance information based on sensed rotational velocity or change in velocity of teeth 322, to an ABS electronic control unit (not shown) via an electrical cable (not shown). Based on the information received, the electronic control unit is capable of controlling the brake engagement under predefined circumstances as programmed into the unit. It is to be understood that first exemplary embodiment tone ring with protective filler 300 could be formed of any material which produces a magnetic field disruption capable of sufficient detection by the ABS sensor without affecting the overall concept or operation of the present invention.

In accordance with an important feature of the present invention, and with reference to FIGS. 4-5, first exemplary embodiment tone ring with protective filler 300 includes a protective filler 350. Protective filler 350 preferably is formed of a non-magnetic hard polymeric material, such as a thermoset plastic or urethane. With reference to FIG. 5, protective filler 350 includes a continuous circumferentially extending base 352 formed over the outboard and radially inward surface of teeth 322 and extends outboardly and radially inwardly from the teeth. A plurality of projections 354 are integrally formed with base 352 and extend inboardly from the base into spaces 324 disposed between teeth 322. Each one of plurality of projections 354 preferably extends transversely inboardly from base 352 into a respective one of spaces 324, to a distance in which an inboard surface 355 of each one of the projections is coplanar with inboard surfaces 323 of its respective adjacent teeth 322. Alternatively, each projection 354 could extend transversely inboardly from base 352 to a distance that is at least about eighty percent of the transverse length L of its respective adjacent teeth 322, without affecting the overall concept or operation of the present invention. In addition, inboard surfaces 355 of projections 354 can be slightly concave or slightly convex without affecting the concept or operation of the present invention. It is to be understood that each projection 354 extends completely between adjacent teeth 322 to support the teeth.

Because plurality of projections 354 extend inboardly into spaces 324 disposed between teeth 322, the projections prevent road or ground debris, such as stones, from becoming lodged between the teeth and potentially damaging or misaligning the associated ABS sensor. In addition, because circumferentially extending base 352 is formed on and covers the outboard surface of teeth 322 and extends outboardly from the teeth, and the base is formed of a hard material, protective filler 350 provides additional support to the teeth and prevents the teeth from becoming bent or damaged by road or ground debris encountered during vehicle operation.

Alternatively, protective filler 350 could be formed of another non-magnetic material, preferably zinc, or non-magnetic stainless steel, brass, aluminum, or other non-polymeric materials, such as ceramic. When protective filler 350 is formed of zinc, it is preferably pure zinc formed within spaces 324 between teeth 322, for example, by injecting pure zinc into a closed die that contains tone ring body 318, pouring melted zinc in an open mold containing the tone ring body, or via galvanization. In such instances, protective filler 350 may or may not include circumferentially extending base 352 integrally formed with plurality of projections 354 on the outboard surface of teeth 322. More specifically, when protective filler 350 is formed of a non-magnetic metal or ceramic material, the material can be disposed within spaces 324 between each respective pair of teeth 322 and be rigidly attached to teeth 322 by any suitable means, such as sintering or induction welding. When non-magnetic metals or ceramic materials are utilized to form protective filler 350, the filler could also be cast or molded between teeth 322 utilizing molten material, or could even be press fit between the teeth. In addition, in such instances, protective filler 350 can extend outboardly or inboardly between teeth 322 to a distance less than or about equal to transverse length L of the teeth without affecting the overall concept or operation of the present invention. It is to be understood that protective filler 350 extends completely between adjacent teeth 322 to support the teeth. It is also to be understood that protective filler 350 can be formed of any hard, non-magnetic material which does not interfere with detection of teeth 322 by the ABS sensor of the vehicle ABS, and is capable of withstanding repeated impacts from road debris without diminishing performance of the material and without affecting the overall concept and operation of the present invention.

In addition, when formed with either a non-magnetic metal material, ceramic material, or polymeric material in accordance with the disclosure above, protective filler 350 could include a film or thin layer (not shown) of the selected material formed over inboard surfaces 323 of teeth 322 by any suitable means. For example, the film could be formed of a polymeric material integrally formed with projections 354. In another example, the film could be a coating applied over inboard surfaces 323 and 355 of teeth 322 and projections 354, respectively, such as a zinc-rich coating applied by any suitable means. The zinc-rich coating could be applied in a powder form or as a liquid/suspension. When the film is a zinc-rich coating applied in powder form, the coating preferably includes a zinc content that is in a range of from about ten (10) percent zinc to about ninety-nine (99) percent zinc by weight in a dried film. More preferably, the zinc-rich coating applied in powder form includes a zinc content that is in the range of from about seventy (70) percent zinc to about ninety (90) percent zinc by weight in a dried film. When the film is a zinc-rich coating applied as a liquid/suspension, the coating preferably includes a zinc content that is in the range of from about ten (10) percent zinc to about ninety-nine (99) percent zinc by weight in a dried film. More preferably, the zinc-rich coating applied as a liquid/suspension includes a zinc content that is in a range of from about seventy (70) percent zinc to about ninety-six (96) percent zinc by weight in a dried film. Most preferably, the zinc-rich coating applied as a liquid/suspension includes a zinc content that is in a range of from about eighty-five (85) percent zinc to about eighty-nine (89) percent zinc by weight in a dried film. The film can include any thickness which does not interfere with the ability of the ABS sensor to sufficiently detect disruptions of the ABS sensor magnetic fields caused by teeth 322 during operation of the vehicle.

In this manner, the film provides additional protection to teeth 322. More specifically, the film protects inboard surfaces 323 of teeth 322 by providing a barrier to contaminants which may splash on first exemplary embodiment tone ring with protective filler 300, such as water, brine, or road salts, during operation of the vehicle, and in turn prevents potential corrosion of the teeth from such contaminants. In instances where the film is integrally formed with inboard surfaces 355 of plurality of projections 354, because the outboard surfaces and radially inward surfaces of the teeth are effectively covered by continuous circumferentially extending base 352 and the film covers inboard surfaces 323 of teeth 322, the teeth are effectively encapsulated within protective filler 350, which in turn provides corrosion protection from contaminants to all surfaces of the teeth.

Thus, first exemplary embodiment tone ring with protective filler 300 of the present invention minimizes the potential for road debris to damage the tone ring teeth, and/or become lodged between adjacent teeth and misalign or damage the ABS sensor, and minimizes the potential for road contaminants to corrode the tone ring teeth during operation of the vehicle, thereby increasing tone ring life and minimizing vehicle maintenance and repair costs.

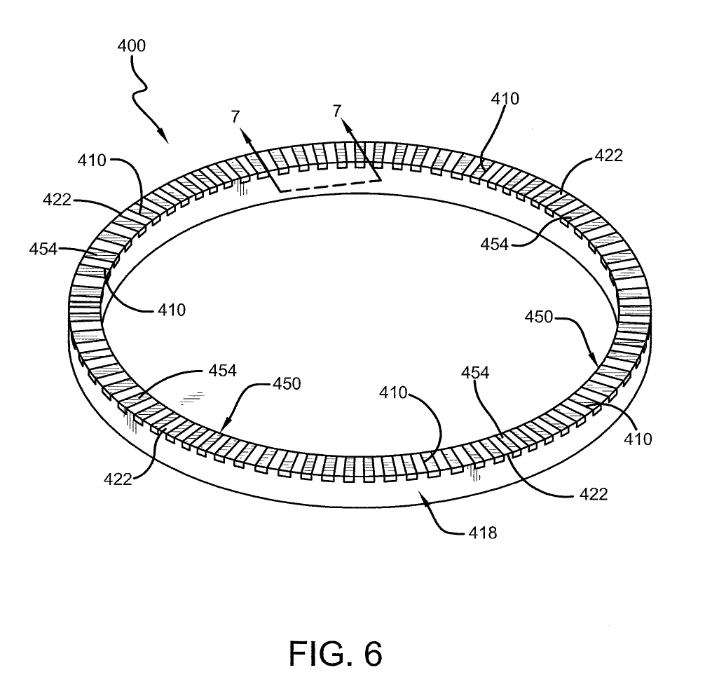

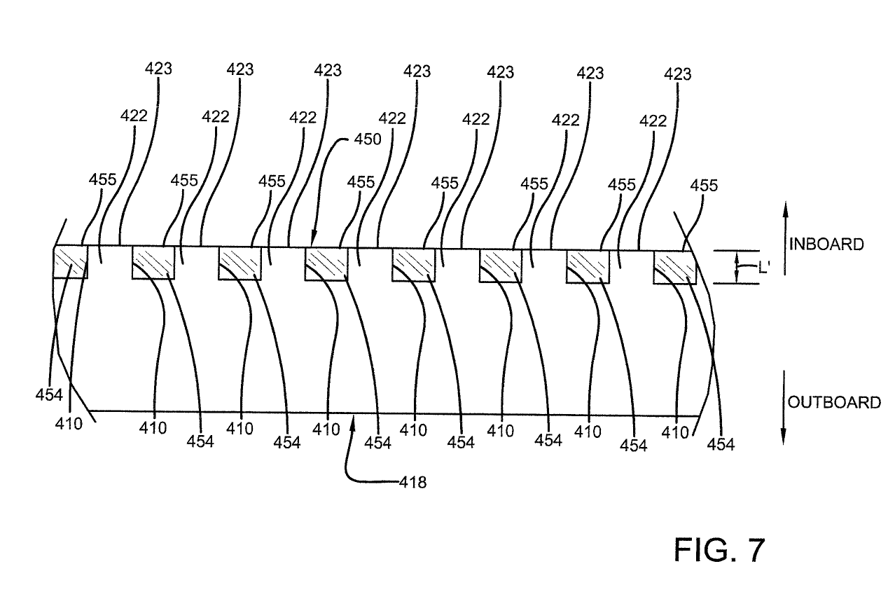

A second exemplary embodiment tone ring with protective filler of the present invention is shown in FIGS. 6 and 7, and is indicated generally at 400. Second exemplary embodiment tone ring with protective filler 400 is similar in function to first exemplary embodiment tone ring with protective filler 300, but includes a solid tone ring structure, as will be described below. As a result, only the differences between second exemplary embodiment tone ring with protective filler 400 and first exemplary embodiment tone ring with protective filler 300 will be described in detail.

With reference to FIG. 6, second exemplary embodiment tone ring with protective filler 400 is a discrete component of the type which is mounted to a heavy-duty vehicle rotor, wheel hub, or other wheel end assembly component in a manner known in the art, or alternatively, is integrally formed in the vehicle wheel hub or rotor.

Second exemplary embodiment tone ring with protective filler 400 is utilized in a heavy-duty vehicle ABS (not shown), such as ABS 235 (FIG. 2). Second exemplary embodiment tone ring with protective filler 400 includes a solid body 418 formed of a suitable material, such as powdered metal or steel. Body 418 is formed with a plurality of circumferentially spaced notches 410 in its inboard side. Alternatively, notches 410 can be machined into body 418. A plurality of teeth 422 are circumferentially spaced around the inboard facing surface of body 418 between respective notches 410, the function of which will be described below.

Body 418 of second exemplary embodiment tone ring with protective filler 400 is formed of a magnetic material capable of disrupting the magnetic fields produced by an ABS sensor (not shown) of the vehicle ABS, such as ABS sensor 250 described above. Body 418 preferably is formed of a ferrous powdered metal, and because of the ferrous powdered metal's magnetic properties, can usually be sensed most effectively by the ABS sensor. Because of the magnetic properties of the material used to form body 418, teeth 422 disrupt magnetic fields produced by the ABS sensor as second exemplary embodiment tone ring with protective filler 400 rotates past the ABS sensor during vehicle operation. The ABS sensor in turn detects the disruptions and sends signals based on the detected disruption of magnetic fields, such as distance information based on sensed rotational velocity or change in velocity of teeth 422, to an ABS electronic control unit (not shown) via an electrical cable (not shown). Based on the information received, the electronic control unit is capable of controlling the brake engagement under predefined circumstances as programmed into the unit. It is to be understood that second exemplary embodiment tone ring with protective filler 400 could be formed of any material which produces a magnetic field disruption capable of sufficient detection by the ABS sensor without affecting the overall concept or operation of the present invention.

In accordance with an important feature of the present invention, second exemplary embodiment tone ring with protective filler 400 includes a non-magnetic protective filler 450 disposed in each notch 410. Protective filler 450 can be formed of a hard polymeric material, such as a thermoset plastic or urethane. Protective filler 450 is disposed within each notch 410 and extends inboardly from body 418 between its respective teeth 422 to form fillings 454. Each one of fillings 454 preferably completely fills each of notches 410 so that an inboard surface 455 of each of the fillings is coplanar with inboard surfaces 423 of its respective adjacent teeth 422, but alternatively could extend transversely inboardly from body 418 to a distance that is at least about eighty percent of the transverse length L′ of teeth 422, without affecting the overall concept or operation of the present invention. In addition, inboard surfaces 455 of each filling 454 can be slightly concave or slightly convex without affecting the concept or operation of the present invention. It is to be understood that each filling 454 extends completely between adjacent teeth 422 to support the teeth.

Because fillings 454 of protective filler 450 are disposed between teeth 422, the fillings prevent the teeth from becoming bent or damaged by road or ground debris encountered during vehicle operation and prevent road or ground debris, such as stones, from becoming lodged between the teeth and potentially damaging or misaligning the associated ABS sensor.

Alternatively, fillings 454 of protective filler 450 could be formed of another non-magnetic material, preferably zinc, or non-magnetic stainless steel, brass, aluminum, or other non-polymeric materials, such as ceramic. When protective filler 450 is formed of zinc, it is preferably pure zinc formed within notches 410 between teeth 422, for example, by injecting pure zinc into a closed die that contains tone ring body 418, pouring melted zinc in an open mold containing the tone ring body, or via galvanization. When fillings 454 are formed of a non-magnetic metal or ceramic material, the material can be disposed within notches 410 between each respective pair of teeth 422 and be rigidly attached to the teeth by any suitable means, such as sintering or induction welding. When non-magnetic metals or ceramic materials are utilized to form fillings 454, the fillings could also be cast or molded between teeth 422 utilizing molten material, or could even be press fit between the teeth. In addition, in such instances, fillings 454 can extend outboardly or inboardly between teeth 422 to a distance less than or about equal to the transverse length L′ of the teeth without affecting the concept or operation of the present invention. It is to be understood that each filling 454 extends completely between adjacent teeth 422 to support the teeth. It is also to be understood that protective filler 450 can be formed of any hard, non-magnetic material which does not interfere with detection of teeth 422 by the ABS sensor of the vehicle ABS, and is capable of withstanding repeated impacts from road debris without diminishing performance of the material and without affecting the overall concept or operation of the present invention.

In addition, when formed with either a non-magnetic metal material, ceramic material, or polymeric material in accordance with the disclosure above, protective filler 450 could include a film or thin layer (not shown) of the selected material formed over inboard surfaces 423 of teeth 422 by any suitable means. For example, the film could be formed of a polymeric material integrally formed with fillings 454. In another example, the film could be a coating applied over inboard surfaces 423 and 455 of teeth 422 and fillings 454, respectively, such as a zinc-rich coating applied by any suitable means. The zinc-rich coating could be applied in a powder form or as a liquid/suspension. When the film is a zinc-rich coating applied in powder form, the coating preferably includes a zinc content that is in a range of from about ten (10) percent zinc to about ninety-nine (99) percent zinc by weight in a dried film. More preferably, the zinc-rich coating applied in powder form includes a zinc content that is in the range of from about seventy (70) percent zinc to about ninety (90) percent zinc by weight in a dried film. When the film is a zinc-rich coating applied as a liquid/suspension, the coating preferably includes a zinc content that is in the range of from about ten (10) percent zinc to about ninety-nine (99) percent zinc by weight in a dried film. More preferably, the zinc-rich coating applied as a liquid/suspension includes a zinc content that is in a range of from about seventy (70) percent zinc to about ninety-six (96) percent zinc by weight in a dried film. Most preferably, the zinc-rich coating applied as a liquid/suspension includes a zinc content that is in a range of from about eighty-five (85) percent zinc to about eighty-nine (89) percent zinc by weight in a dried film. The film can include any thickness which does not interfere with the ability of the ABS sensor to sufficiently detect disruptions of the ABS sensor magnetic fields caused by teeth 422 during operation of the vehicle.

Second exemplary embodiment tone ring with protective filler 400 provides the same benefits as described with reference to first exemplary embodiment tone ring with protective filler 300. Second exemplary embodiment tone ring with protective filler 400 thus minimizes the potential for road debris to damage the tone ring teeth or associated ABS components, and/or misalign the ABS sensor, and minimizes the potential for road contaminants to corrode the tone ring teeth during operation of the vehicle, thereby increasing tone ring life and minimizing vehicle maintenance and repair costs.

The present invention also includes a method of forming/attaching protective filler 350 on/to first exemplary embodiment tone ring with protective filler 300 and protective filler 450 on/to second exemplary embodiment tone ring with protective filler 400. The method includes steps in accordance with the description that is presented above and shown in FIGS. 4-7.

It is to be understood that the structures and arrangements of the above-described tone ring with protective filler of the present invention may be altered or rearranged without affecting the overall concept or operation of the present invention. For example, the concepts of the present invention could be applied to tone rings with different structures than those disclosed, such as tone rings which are integrally formed with heavy-duty vehicle brake rotors or wheel hubs, without affecting the overall concept or operation of the present invention. The concepts of the present invention could also be applied to tone rings with divisions other than teeth without affecting the overall concept or operation of the present invention. In addition, the concepts of the present invention could be applied to any sensing applications which utilizes magnetic field disruption, including those that do not involve ABS, such as direction or distance sensing, without affecting the overall concept or operation of the present invention. In addition, the tone ring with protective filler of the present invention may be employed with other types of axles, rotors, and/or wheel end assemblies than those shown and described above without affecting the overall concept or operation of the invention. It is to be understood that the tone ring with protective filler of the present invention could be utilized with other braking systems than those shown and described, such as those using a drum brake, without affecting the overall concept or operation of the present invention. It is also to be understood that the tone ring with protective filler of the present invention could be utilized on other types of vehicles than those shown or described without affecting the overall concept or operation of the present invention. Moreover, while reference herein has been made generally to heavy-duty vehicles for the purposes of convenience, it has been with the understanding that such reference includes trucks, tractor-trailers and semi-trailers, and trailers thereof. Also, different structural configurations of protective filler 350, 450 are contemplated, such as filler configurations that do not have a continuous base 352, filler configurations that do not fill the entire spaces/notches 324, 410 between teeth 322, 422, and the like.

In the foregoing description, certain terms have been used for brevity, clearness and understanding; but no unnecessary limitations are to be implied therefrom beyond the requirements of the prior art, because such terms are used for descriptive purposes and are intended to be broadly construed. Moreover, the present invention has been described with reference to a specific embodiments. It shall be understood that these illustrations are by way of example and not by way of limitation, as the scope of the invention is not limited to the exact details shown or described. Potential modifications and alterations will occur to others upon a reading and understanding of this disclosure, and it is understood that the invention includes all such modifications and alterations and equivalents thereof.

Having now described the features, discoveries and principles of the invention, the manner in which the tone ring with protective filler of the present invention is used and installed, the characteristics of the construction, arrangement and method steps, and the advantageous, new and useful results obtained; the new and useful structures, devices, elements, arrangements, processes, parts and combinations are set forth in the appended claims.

What is claimed is:

1. A tone ring of an anti-lock braking system for vehicles comprising:
a body, said body including a plurality of divisions formed of a material capable of being sensed by a sensor of said anti-lock braking system; and
a filler, said filler being disposed at least between adjacent ones of said divisions and being formed of material that does not interfere with the ability of said sensor to sense the divisions, whereby said filler provides protection to said divisions and the sensor.

2. The tone ring of an anti-lock braking system for vehicles of claim 1, wherein said divisions are formed of a magnetic material and said filler is formed of a non-magnetic material.

3. The tone ring of an anti-lock braking system for vehicles of claim 2, wherein said magnetic metal is a ferrous metal selected from the group consisting of steel, cast iron, magnetic stainless steel, and powder metal.

4. The tone ring of an anti-lock braking system for vehicles of claim 2, wherein said non-magnetic material is ceramic.

5. The tone ring of an anti-lock braking system for vehicles of claim 2, wherein said non-magnetic material filler is selected from the group consisting of zinc, non-magnetic stainless steel, brass, and aluminum.

6. The tone ring of an anti-lock braking system for vehicles of claim 2, wherein said non-magnetic material is a polymeric material.

7. The tone ring of an anti-lock braking system for vehicles of claim 6, wherein said polymeric material is selected from the group consisting of thermoset plastic and urethane.

8. The tone ring of an anti-lock braking system for vehicles of claim 1, wherein said tone ring is a discrete component capable of being mounted to a wheel end assembly component or an air brake system component of said heavy-duty vehicle.

9. The tone ring of an anti-lock braking system for vehicles of claim 1, wherein said tone ring is integrally formed with a wheel end assembly component or an air brake system component of said heavy-duty vehicle.

10. The tone ring of an anti-lock braking system for vehicles of claim 1, wherein a surface of said filler facing said sensor is coplanar with surfaces of adjacent ones of said divisions facing the sensor.

11. The tone ring of an anti-lock braking system for vehicles of claim 1, wherein said filler extends transversely within adjacent ones of said divisions at least eighty percent of a transverse length of said divisions.

12. The tone ring of an anti-lock braking system for vehicles of claim 1, wherein said filler is integrally formed with a base, said base extending continuously circumferentially over surfaces of said divisions opposite said sensor.

13. The tone ring of an anti-lock braking system for vehicles of claim 1, wherein said divisions are coated with a thin film.

14. The tone ring of an anti-lock braking system for vehicles of claim 13, wherein said thin film is integrally formed with said filler.

15. The tone ring of an anti-lock braking system for vehicles of claim 13, wherein said thin film is a zinc-rich coating.

16. The tone ring of an anti-lock braking system for vehicles of claim 5, wherein said non-magnetic material filler is pure zinc.

17. The tone ring of an anti-lock braking system for vehicles of claim 1, wherein said filler is sintered or induction welded between said divisions.

18. The tone ring of an anti-lock braking system for vehicles of claim 1, wherein said filler is disposed between notches formed between adjacent ones of said divisions.

19. The tone ring of an anti-lock braking system for vehicles of claim 1, wherein said filler is disposed between spaces formed between adjacent ones of said divisions.

20. The tone ring of an anti-lock braking system for vehicles of claim 1, wherein said divisions are teeth.
